(19) United States
(12) Patent Application Publication
(10) Pub. No.: US 2005/0254714 A1
(43) Pub. Date: Nov. 17, 2005

(54) Systems and methods for data transfer with camera-enabled devices

(76) Inventor: Ramakrishna Anne, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/844,953

(22) Filed: May 13, 2004

(51) Int. Cl. H04N 7/14; G06K 9/36

(52) U.S. Cl. 382/233; 348/14.01

(57) ABSTRACT

A method comprises encoding data by a first device, displaying the encoded data on a display of a first device, capturing an image of the encoded data displayed on the display with a camera associated with a second device, and converting the image to the data by the second device.

### FIELD OF THE INVENTION

The present invention is broadly related to data transfer and specifically to systems and methods for data transfer with camera-enabled devices.

### DESCRIPTION OF RELATED ART

Portable electronic devices, or mobile appliances, such as Personal Digital Assistants (PDAs), cellular telephones, and the like, commonly incorporate digital cameras, primarily for imaging purposes. These devices typically employ various methods for transferring data into and out of the device. This data is typically transferred to or from a general purpose processor-based device such as a Personal Computer (PC) at a relatively fast rate via a wired or wireless connection.

A wired connection may be a serial connection, such as a Universal Serial Bus (USB) connection. Problematically, a serial port or USB interface needs to be available on both devices, and a compatible cable must be used to physically connect the devices.

Relatively high speed wireless connections used to transfer data between a portable electronic devices and a PC or the like may include a BLUETOOTH™ wireless interface, or an even more high speed “Wi-Fi” connection, such as a IEEE 802.11 (a/b/g) compliant connection. Problematically, both of these relatively high speed wireless solutions require additional hardware. Although such wireless hardware may be incorporated into the portable electronic device and/or PC, such inclusion greatly increases the cost and possibly the bulk of the device. Also, older hardware may not be capable of supporting retrofitted Wi-Fi or BLUETOOTH™ hardware. Additionally, it is possible to intercept the data exchange within the range of the device, five to ten meters for BLUETOOTH™ and hundreds of meters for Wi-Fi, presenting a security concern.

Another, lower speed, wireless data transfer method typically employed by portable electronic devices, (particularly PDAs, notebook computers, and some cellular telephones) may employ infrared (IR) radiation as a medium, typically employing a standard promulgated by the Infrared Data Association (IrDA). A PDA typically has a single element IR emitter which can transmit, or radiate, a serial data stream. Typically, a single element detector in the PDA detects information that is transmitted over infrared, typically from other PDAs or a PC. A combination of such an emitter and detector is often termed an “IR port.” Other devices, such as a notebook computer, and peripherals, such as printers may employ IR ports. For example, a notebook computer with an IR port may employ a printer with an IR port for wireless printing. Problematically, both the transmitting and receiving device need at least a corresponding portion of the IR hardware and the devices need to be aligned for the transfer of data.

Other devices, portable and otherwise, may read light to gather data. For example, bar code readers read laser light reflected off a static bar code pattern. Systems for transferring data from a Cathode Ray Tube (CRT) video display of a PC, or the like, to a portable information device such as a multifunction electronic wristwatch using the CRT video display as a video signal generator to transmit binary coded transmission pulses are known. The portable information device of such a system has a dedicated photosensor to detect light pulses when the photosensor is directed toward the screen. Similar methods of data transfer using a CRT's light or RF emissions to generate a single signal, which is received by a special purpose detector, or the like, associated with the portable electronic device, are also known. Such schemes transmit one data bit at a time, serially, to a single optical intensity detector. These methods are typically tied to a CRT raster generation method. Also it is known to modify a television signal format and television CRT raster scan methods to transmit data, thereby enabling sensors to be placed outside the line of sight of the television, possibly in fixed locations.

### BRIEF SUMMARY OF THE INVENTION

An embodiment of a method comprises encoding data by a first device, displaying the encoded data on a display of a first device, capturing an image of the encoded data displayed on the display with a camera associated with a second device, and converting the image to the data by the second device.

An embodiment of a system for transferring data comprises a first device hosting data to be transferred and selectively displaying the data in an encoded format, and a second device, itself comprising an imaging device capturing an image of the encoded data displayed by the first device, and logic for decoding the encoded data to provide the data in the second device.

An embodiment of a data transmission medium comprises a display displaying encoded data, and a camera-enabled appliance adapted to capture an image of the encoded data displayed on the display for decoding.

### BRIEF DESCRIPTION OF THE DRAWINGS

FIG. 1 is a diagrammatic representation of an embodiment of the present systems showing data-flow in accordance with an embodiment of the present methods;

FIG. 2 is a diagrammatic illustration of an embodiment of a general purpose processor-based device adapted to employ embodiments of the present systems and methods;

FIG. 3 is a diagrammatic illustration of an embodiment of a camera-enabled PDA adapted to employ embodiments of the present systems and methods;

FIG. 4 is a diagrammatic illustration of an embodiment of a camera-enabled cellular telephone adapted to employ embodiments of the present systems and methods; and

FIG. 5 is a diagrammatic illustration of an embodiment of a digital camera adapted to employ embodiments of the present systems and methods.

### DETAILED DESCRIPTION

The present invention provides systems and methods for data transfer between multiple devices without use of a physical wired, or traditional wireless, connection between the two devices. The present invention provides systems and methods for moving data into and out of a camera-enabled mobile appliance, wirelessly and rapidly, using very little power and using hardware already incorporated into the device. The present invention also provides systems and methods for wirelessly moving data into and out of memory associated with a digital camera, rapidly, using very little power and using hardware already incorporated into the camera. The present systems and methods use a camera, which may be associated with a mobile appliance and which is normally meant for imaging applications, and use the screen of a processor-based device, which is normally used for displaying images and text, to transfer data from the processor-based device to the mobile appliance. Additionally, in accordance with some embodiments of the present invention, a digital camera associated with a PC or other processor-based device may be used to receive data transmitted using a display of a mobile appliance. In other words, the present invention uses a display as a medium for transmitting or moving data in and out of a mobile appliance and/or processor-based device.

The present systems and methods place a visual “constellation” on a transmitting screen, and by varying the spacing, color and/or brightness, transmit data. Elements of this constellation may be visual information that is to be displayed. The data component of this constellation may be transmitted by varying the brightness, color or a path between different regions of the screen and the data may be transmitted in such a manner as to not destroy the visual information portion of this constellation. The present systems and methods may vary the spacing, color and/or brightness to provide a robust data transmission. Different encoding techniques may be used to transmit data. Such a transmission may address ambient light issues by using two or more regions on the screen. For example, data may be encoded such that one region of the screen is brighter than another region. A data bit, such as a one, is communicated and if it is less bright a different data bit is communicated, such as a zero.

The present invention employs high bandwidth elements for both the transmitter and the receiver, namely, a display acting as multi-element transmitter and a camera acting as a multi-element receiver. The present invention leverages the large bandwidth that the display system of most processor-based systems, and cameras increasingly common in devices, to use a display and image capture mechanism to transfer data. Thereby, the present systems and methods enable general-purpose, fast, secure, and low-cost data transfer.

The present invention employs a medium for data transfer comprising a source display (e.g. PDA display, wireless phone display, PC display, ATM display, etc.) as a data transmitter and a camera associated with the receiving device (e.g. the camera of a camera phone, a camera associated with a PDA, a digital camera, a PC connected digital WebCAM, etc.) as a data receiver. Throughput, or useful data transfer capacity, of embodiments of the present systems and methods may be influenced by rise and fall times of the transmitting display, resolution and color depth of the display, camera sensitivity and resolution, display and camera sub-system latencies, separation between the screen and camera, co-planarity between the display and camera, surface reflections, characteristics of ambient lighting, display front and back-lighting, protocols used, error-correction, encoding schemes, and the like.

Advantageously, the present systems and methods may take advantage of improving resolution and sensitivity in the imaging sensors of camera-enabled devices to enhance data reception, as well as improving technology in displays to improve transmission. The present invention provides techniques for data transmission using a variety of display and imaging technologies. Such displays may be based on Organic Light Emitting Diodes (OLEDs), Liquid Crystal Displays (LCDs), CRTs, Light Emitting Diodes (LEDs). Imaging devices may include Charge-Coupled Device (CCD) or Complementary Metal Oxide Semiconductor (CMOS)-based cameras, or any other device capable of capturing visual information. Advantageously, the present systems and methods require no extra hardware for transferring data between information appliances and very fast data transfer is possible with OLED, CRT and LCD displays. As a further advantage, data transfer employing the present systems and methods can be made very secure due to encryption and/or proximity requirements. The present invention enables secure data transmission even from older Automated Teller Machines (ATMs) (e.g. sending a receipt or account statement to a PDA or camera enable wireless phone), billboards (e.g. sending directions or a menu to a PDA or camera enable wireless phone), or the like. In accordance with embodiments of the present invention, it may be possible to transfer data without any perceptible changes to the displayed content/image in some cases. The present invention may employ data ordering and encoding for optimal data transmission with existing display sub-systems, and may employ techniques to support a variety of display and camera resolutions and pixel spacings. The present invention also may employ techniques for mitigating some common impairments, such as back-light, front-light and/or ambient light interference, and/or low contrast in display or camera imaging elements. Techniques for compensating for hand movement and/or vibration of the camera, and/or display vibration, may filter out low frequency signals and the like. The present invention may employ data encoding and display techniques for security and eavesdropping prevention.

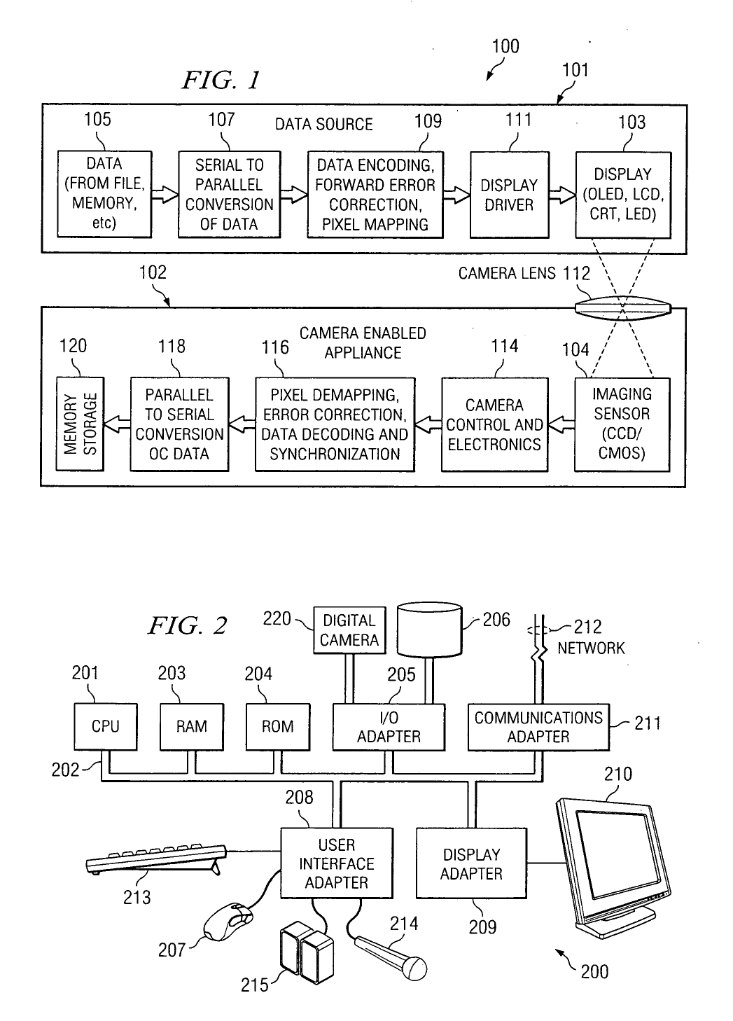

FIG. 1 is a diagrammatic representation of system embodiment 100 showing data-flow in accordance with an embodiment of the present invention. The present systems may employ transmitter data source 101 and receiver camera-enabled appliance 102, with a transmission medium comprised of transmitter display 103 and receiver imaging sensor 104. The present systems and methods may not employ any additional hardware, may be very power efficient and the system interfaces employed for display and camera input may already be tuned for high throughput, both as an output to screen 103, and as an input through imaging sensor 104. Advantageously, all signal processing requirements for data communication in accordance with the present invention may be handled by respective CPUs of camera-enabled appliance 102 and data source 101. The present invention may employ high level applications on camera-enabled appliance 102 and data source 101. Typically the image display and the image capture portions of a device are the highest bandwidth systems in a camera-enabled PDA or a camera phone, because the amount of data to be displayed on the screen is very bandwidth demanding. These platforms are typically designed from the bottom-up to be able to support the high bandwidth required by the screen and/or the camera.

Data source 101 may be a PC, PDA, cellular phone, ATM, Billboard, panel indicator, enunciator, traffic light or other processor device. In accordance with the present invention, data 105, such as a data file that may be stored or active in data source 101, may be converted from a serial stream into one or more parallel data streams at 107. Pixel mapper 109 takes the incoming data stream(s) and determines how many pixels may be assigned to each stream and the content of the stream(s) in such a manner as to maximize data throughput. Since displays have limited rise and fall times, the present invention may transmit data using multiple regions, or multiple pixels, of a display screen, in a parallel manner, in order to maximize throughput. Each pixel, or each region, of the screen may be able to transmit a certain amount of information, depending on bandwidth, such as may be a function of the rise and fall times of the emitting elements (display 103) and the receiving elements (camera 104). Data to be transmitted may be parallelly transmitted using multiple “data screens” which can be displayed on different regions of transmitting element display 103. As there may be interference between the different regions of the screen, the data may be encoded at 109 in such a manner as to provide a robust data transmission. For example, various methods of error correction, such as forward error correction (FEC) or the like, may be applied for the encoded data, or redundant databases and framing may be used, so as to enhance detection and correction of errors. Transmitter data source 101 may employ different regions of the screen to exclusively transmit clock and framing information. As transmitting screen 103 and receiving camera 104 may have different resolutions and/or different ordering of pixels, a flexible scheme of pixel mapping may be employed at 109 where pixel spacing and density of each of the pixels may be varied as required. For example, one data stream may be transmitted on one pixel, or a data stream may be bundled in a collection of pixels, such as twenty pixels used as a single transmission element.

Pixel mapper 109 may employ feedback to make determinations as to the number and location of pixels to be employed by a data stream. The pixel mapper may vary the loading per pixel, such as, by way of example, transmitting one bit per pixel, two bits per pixel or seven bits per pixel, depending on what receiver 102 is reporting back it is receiving. Alternatively, different regions of transmitting screen 103 may display different levels of loading. For example, one bit per pixel may be transmitted by one region of the screen, while four bits per pixel is transmitted by a different region of the screen. The different regions may transmit the same information. Resultantly, the receiving camera-enabled appliance 102 may automatically determine the densest region of the screen from which it can effectively receive data, without using feedback. Alternatively, a device user might be able to manually select the region to be used.

The encoded information is sent to the regular display system of transmitting data source device 101. Display driver 111 normally displays text and image information on the screen. The present invention manipulates some of the displayed content in such a way as to transmit data. The present invention may use the entire display (103) just for the purpose of transmitting data such that there is no visual information to be seen by a user. Alternatively, existing visual content that is being displayed by screen 103 may be manipulated it in such a manner as to not destroy this content (i.e., there is no change to the content that the user can perceive). The data is transmitted in the background, so to say, by varying the brightness and/or color of the existing information that is already on the screen in such a manner as to be undetectable to the human eye. However, camera 104 is able to detect and record the variations in order to recover the transmitted information. This background transmission may employ a slower bit rate than a preemptive transmission described above. The present systems and methods may, particularly when transmitting data with an intent to not interfere with displayed images, modulate color and/or brightness of window title bars, edges or corners of the transmitting screen, or other portions of a screen that a user normally does not focus upon, for transmitting data. These or other portions of a display may, in effect, be reserved for data transmission in accordance with the present invention.

Factors that influence the effective throughput of a system embodying the present invention may, at least in part, depend on the color density that display 103 can support, pixel density (pixels per square inch or millimeter), the rise and fall time of display 103, reflections from screen 103, and the like. Advantageously, OLEDs have a very fast rise and fall time, so the transmitting capacity of OLEDs may be superior to other types of displays. Conversely, LCD monitors may only support a slower rate due to their lower contrast and brightness. PDA displays typically have a relatively low brightness level compared to other types of displays. So close proximity to the screen may be used to enhance throughput from the display. PDA displays often employ reflective or transflective LCDs, which use as much of the ambient light as possible to provide display brightness. Such reflective or transflective LCD displays may use birefringence, whereby modulation of incident light may enable the LCD display to transmit a data stream. Alternatively, when a PDA is in a transmitting mode in accordance with the present invention, it may employ a back-light to modulate the LCD for transmitting data. Thus, depending on the ambient light, throughput capability for a PDA as a data transmitter may vary. Cellular telephone displays have similar issues when used as a transmitter. However, both cell phones and PDAs are increasingly using OLEDs as displays, which have a much greater inherent capacity to transmit data in accordance with the present invention, as they are brighter and have no reflective mode of operation. OLED displays transmit light outward which enhances throughput in the present systems and methods. In OLED displays, each pixel may act as an independent light source without the need for a common illumination source. Advantageously, this facilitates elimination of strong background emission that might result from the use of a common illumination source such as a back-light or front-light.

On the other hand, resolution in digital cameras, even those traditionally having lower resolutions such as the cameras incorporated into PDAs and camera phones, is improving, at lower costs. Therefore, use of a higher resolution, more light sensitive, cameras may enhance throughput from a reflective LCD display or the like.

With the data to be transferred displayed on screen 103, receiving camera-enabled device 102, such as may employ a camera imaging system, captures the data as it is streamed on screen 103. This camera imaging system might comprise one or more lenses 112 incident to imaging sensor 104, which may be a CMOS or a CCD camera sensor. Camera-enabled appliance 102 may be a camera phone, PDA, digital camera, a security camera, a PC with a WebCAM, a closed circuit television camera, or the like. Logic, such as camera control and electronics 114 associated with camera or camera-enabled device 102 translates this captured light information into either an analog or digital electronic format. Thereby, the present systems extract an electrical signal derived from the incident light received by the camera element 104. Camera enable devices typically have at least Video Graphics Array (VGA) resolution, 640 by 480 pixels with a 1.33:1 aspect ratio (0.3 Megapixels). However, digital cameras may have multi-megapixel resolution. The electrical signal that is received by the camera is proportional to the light that is incident on each of the pixels and typically the cameras have at least three color elements. Each pixel will have an intensity as well as a color in various resolutions. Thereby, each pixel may provide eight bits in a dynamic range derived from brightness information extracted from the camera received data. Similarly, the color information for a pixel may be encoded in eight to twelve bits per pixel for each of the additive color primaries, red, green and blue. This brightness and color information is made available in an electronic format and may be processed through communication system 116 where an inverse pixel mapping may be carried out.

At 116, the decoded data is synchronized to transmitter 101, such as by recording a clock provided by transmitting system 101 on screen 103 as a part of the data transmission. The clock may be used to reorder the received data and to facilitate inverse pixel mapping at 116. Synchronization of transmission and reception may employ various techniques for encoding the data. Whereas in a typical communication system a standard header may be used to provide synchronization data, in the present invention, a space-time analog may provide synchronization information, thereby a fixed region in the screen may be used to provide synchronization information such as a clock signal. The brightness or color in one or more regions of screen 103 may be varied to be in sync with the transmitted data. Receiving camera-enabled device 102 may detect those regions and use it as a reference clock for decoding data. Alternatively, the transmitting display's vertical and horizontal sync may be used as a synchronization signal. By way of example, if in transmission four pixels were grouped together as one element, on the receiving side four elements may be used in an attempt to recover data corresponding to the transmitted data. The clock information may be used to arrange this data, and framing information may be used to reorder the data and recover it as various patterns of streams. The various parallel patterns of streams may be combined into a single serial data output at 118, which can be recorded in system memory at storage 120 and be addressed as a file.

FIG. 2 illustrates an example computer system 200 adapted according to embodiments of the present invention. That is, computer system 200 comprises an example system on which embodiments of the present invention may be implemented, such as data source device 101 or camera-enabled appliance 102, of the example implementation of FIG. 1. When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

Central processing unit (CPU) 201 is coupled to system bus 202. CPU 201 may be any general purpose CPU. Suitable processors include without limitation any processor from INTEL's ITANIUM® family of processors, HEWLETT-PACKARD's PA-8500 processor, or INTEL's PENTIUM® family of processors, as examples. However, the present invention is not restricted by the architecture of CPU 201 as long as CPU 201 supports the inventive operations as described herein. CPU 201 may execute the various logical instructions according to embodiments of the present invention. For example, CPU 201 may execute machine-level instructions according to the data-flow described above in conjunction with FIG. 1.

Computer system 200 may also include random access memory (RAM) 203, which may be SRAM, DRAM, SDRAM, or the like. Computer system 200 may include read-only memory (ROM) 204 which may be PROM, EPROM, EEPROM, or the like. RAM 203 and ROM 204 hold user and system data and programs, as is well known in the art. CPU 201, and RAM 203 and/or ROM 204, carry out the serial to parallel, and parallel to serial conversion of data at 107 and 118, respectively, as well as data encoding, FEC and pixel mapping at 109 and pixel demapping, error correcting data decoding and synchronization at 116. Additionally, CPU 201, RAM 203 and/or ROM 204 may carry out camera control functions such as indicated at 114 of FIG. 1.

Computer system 200 also may include input/output (I/O) adapter 205, communications adapter 211, user interface adapter 208, and display adapter 209. Display driver 111 may control operation of display adapter 209 to transmit data using display 210 as described above. I/O adapter 205, user interface adapter 208, and/or communications adapter 211 may, in certain embodiments, enable a user to interact with computer system 200 in order to input information, such as to designate data to be transmitted or to designate parameters of operation of the present systems and methods.

I/O adapter 205 may connect to storage device(s) 206, such as one or more of hard drive, compact disc (CD) drive, floppy disk drive, tape drive, etc. to computer system 200. The storage devices may be utilized when RAM 203 is insufficient for the memory requirements associated with manipulation of data for transmission ordering reception. Communications adapter 211 may be adapted to couple computer system 200 to network 212 (e.g., the Internet, a wide area network, a local area network or the like). User interface adapter 208 couples user input devices, such as keyboard 213, pointing device 207, and microphone 214 and/or output devices, such as speaker(s) 215 to computer system 200. Display adapter 209 is driven by CPU 201 to control the display on display device 210 to, for example, transmit data in accordance with embodiments of the present invention.

Digital camera 220 may be connected to system 200 via an I/O mechanism such as a USB port and may provide functions of imaging sensor 104 and/or camera control 114 of FIG. 1, described above. Camera 220 may be a conventional digital camera intended to capture digital images separate from computer 200 and may be connected to computer 200 for the traditional purpose of downloading such images and/or in accordance with the present invention to provide the aforementioned camera sensor and/or camera control functions. Additionally or alternatively, camera 220 may be a WebCAM or a connected digital camera functioning as a WebCAM. Such a WebCAM can be employed as a receiver by the present systems and methods. The WebCAM can, by way of example, be employed as part of an impromptu network such as might be established between one or more desktop PCs having WebCAMS, and/or one or more camera-enabled notebook computers, and/or one or more camera-enabled devices, in accordance with the present invention.

It shall be appreciated that the present invention is not limited to the architecture of system 200. For example, any suitable processor-based device may be utilized, including, without limitation, personal computers, laptop computers, computer workstations, multi-processor servers, PDAs, camera phones, digital cameras, and the like, as discussed above. Moreover, embodiments of the present invention may be implemented on application specific integrated circuits (ASICs) or very large scale integrated (VLSI) circuits. Persons of ordinary skill in the art may utilize any number of suitable structures capable of executing logical operations according to the embodiments of the present invention.

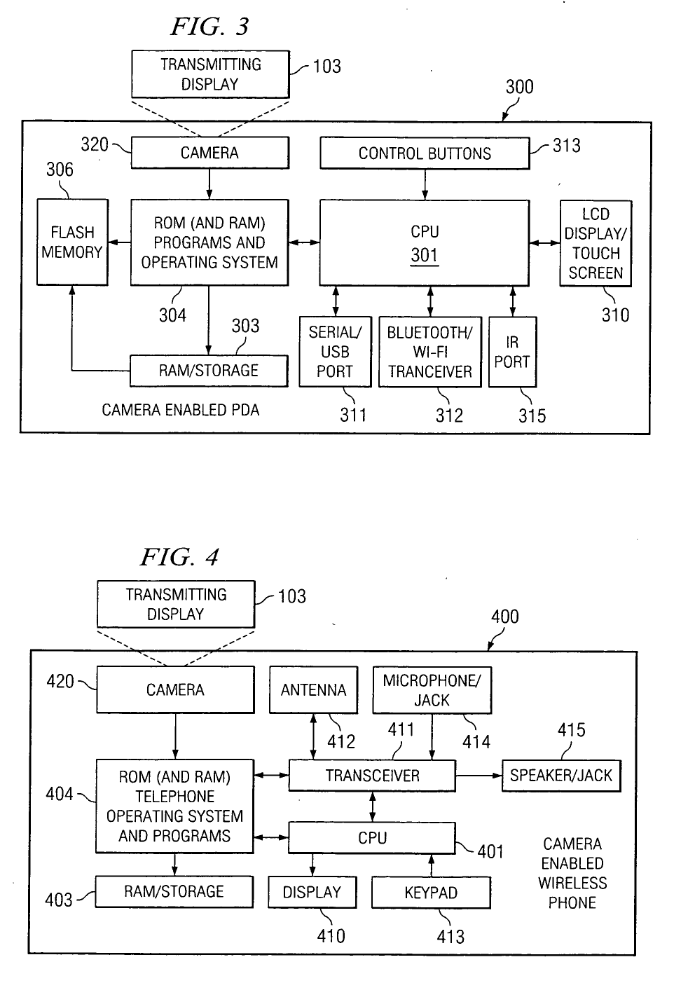

FIG. 3 is a diagrammatic illustration of an embodiment of camera-enabled PDA 300 adapted to employ embodiments of the present systems and methods. PDA 300 may be used as a receiver camera-enabled appliance (such as receiver camera-enabled appliance 102 of FIG. 1). Alternatively or additionally, PDA 300 may be used as a transmitter data source (transmitter data source 101 of FIG. 1). As noted above, camera-enabled PDA 300 need not employ any additional hardware, only software, to implement the present invention and PDA 300 provides very power efficient data transfer as PDA 300 is tuned for high bandwidth throughput for both its camera 320 and its display screen 310. High level applications, executed by CPU 301, ROM 304 and/ or RAM 303, enable PDA 300 to act as either a receiver appliance or a data source. When implemented via executable instructions, various elements of embodiments of the present invention are in essence software code defining operation of various elements of PDA 300. The executable instructions or software code may be obtained from a readable medium such as RAM storage 303, removable flash memory 306, ROM 304, and/or the like. ROM 304 and/or RAM 303 may hold user and system data and programs, as is well known in the art. CPU 301, and RAM 303 and/or ROM 304, may carry out the serial to parallel, and parallel to serial conversion of data, as well as data encoding, FEC, pixel mapping, pixel demapping, error correction, data decoding and synchronization, described above. Additionally, CPU 301, RAM 303 and/or ROM 304 may carry out camera control functions.

PDA 300 may also include conventional components. For example, input to PDA 300 may be accomplished via control buttons 313 and/ or touch screen display 310. Data may be output, and data and/or applications may be conventionally transferred into PDA 300 via a serial or USB port 311, IR port 315, wireless transceiver 312 (using supported BLUETOOTH™ or Wi-Fi protocols) and/or removable flash memory 306.

However, in accordance with the present invention data to be transferred into PDA 300 may be displayed on transmitting device screen 103. In FIG. 3 a transmission medium may comprise transmitter display 103 and PDA camera 320. Camera enable PDA 300 typically has at least VGA resolution. Camera-enabled PDA logic, such as camera control and electronics, which may be resident in ROM/RAM 304 of PDA 300, translates this captured light information from an analog to a digital electronic format. Thereby, the present systems extract an electrical signal derived from the incident light received by the camera 320. Brightness and color information made available in an electronic format may be processed in RAM/ROM 304 where inverse pixel mapping, decoding, error correction and synchronization may be carried out. Data may be output for storage to resident RAM 303 of PDA 300 and/or to flash memory 306 received by PDA 300.

When PDA 300 is acting as a data source, data, such as a data file that may be stored in RAM storage 303 or associated flash memory 306, may be converted from a serial stream into one or more parallel data streams by programs operating in ROM/RAM 304 and executed by CPU 301. Similarly, a pixel mapper operating in ROM/RAM 304 and executed by CPU 301 encodes the data for transmission on PDA display 310, in such a manner as to maximize data throughput. Error correction may be incorporated into the data by ROM/RAM 304 and CPU 301 as well, prior to transmission on screen 310. The encoded data is sent to PDA display 310 and may be presented in the background as described above, without changing display content perceived by a PDA user. The data may be transmitted in parallel fashion using multiple “data screens” which can be displayed on different regions of PDA display 310. As noted above LCD displays, such as PDA display 310 have relatively lower contrast and brightness. Therefore, when a PDA 300 is transmitting data it may employ a back-light to modulate the LCD. However, devices such as PDAs are increasingly employing OLEDs, making the use of such back-light modulation unnecessary.

FIG. 4 is a diagrammatic illustration of an embodiment of a camera-enabled cellular telephone, or camera phone, 400 adapted to employ embodiments of the present systems and methods. Camera phone 400 may be used as a receiver camera-enabled appliance (102 of FIG. 1). Alternatively or additionally, camera phone 400 may be used as a transmitter data source (101 of FIG. 1). As noted above, camera-enabled camera phone 400 need not employ any additional hardware, only software, to implement the present invention. Camera phone 400 provides very power efficient data transfer as camera phone 400 is tuned for high bandwidth throughput for both its camera 420 and its display screen 410. High level applications executed by CPU 401 and ROM/RAM 404 enable camera phone 400 to act as either a receiver appliance or a data source. When implemented via executable instructions, various elements of embodiments of the present invention are in essence software code defining operation of various elements of camera phone 400. The executable instructions or software code may be obtained from a readable medium such as RAM storage 403, ROM 404, and/or the like. ROM 404 and/or RAM 403 may hold user and system data and programs, as is well known in the art. CPU 401 and ROM/RAM 404, may carry out the serial to parallel, and parallel to serial conversion of data, as well as data encoding, FEC, pixel mapping, pixel demapping, error correction, data decoding and synchronization, described above. Additionally, CPU 401 and ROM/RAM 404 may carry out camera control functions.

Camera phone 400 may also include conventional components. For example, conventional input to camera phone 400, such as dialing, may be accomplished via a key pad 413, which may also be used to input text in a multiple-keystroke fashion as is know in the art. Voice communications and/or data may be output, and data and/or applications may be conventionally transferred into camera phone 400 via transceiver 411, using antenna 412. Voice input, for communication or voice recognized instructions may be provided via microphone 414, whereas communicated voice output or phone prompts may be provided via speaker 415. A headset may employ jacks associated with speaker 415 and/or microphone 414.

In accordance with the present invention, data to be transferred into camera phone 400 may be displayed on transmitting device screen 103. In FIG. 4, a transmission medium may comprise transmitter display 103 and phone camera 420. Camera phone 400 typically has at least VGA resolution. Camera phone logic, such as camera control and electronics, which may be resident in ROM/RAM 404 of camera phone 400, translates light information captured by camera 420 from an analog to a digital electronic format. Thereby, the present systems extract an electrical signal derived from the incident light received by the camera 420. Brightness and color information made available in an electronic format may be processed in RAM/ROM 404 where inverse pixel mapping, decoding, error correction and synchronization may be carried out. Data may be output for storage to resident RAM 403 of camera phone 400.

When camera phone 400 is acting as a data source, camera phone resident data, such as a data file that may be stored in RAM storage 403 of camera phone 400 may be converted from a serial stream into one or more parallel data streams by programs operating in ROM/RAM 404 and executed by CPU 401. Similarly, a pixel mapper operating in ROM/RAM 404 and executed by CPU 401 encodes the data for transmission on camera phone display 410, in such a manner as to maximize data throughput. Error correction may be incorporated into the data by ROM/RAM 404 and CPU 401 as well, prior to transmission on screen 410. The encoded data is sent to camera phone display 410 and may be presented in the background as described above, without changing display content perceived by a camera phone user. The data may be transmitted in parallel fashion using multiple “data screens” which can be displayed on different regions of camera phone display 410. As noted above LCD displays, such as camera phone display 410 have relatively lower contrast and brightness. Therefore, when a camera phone 400 is transmitting data it may employ a back-light to modulate the LCD. However, devices such as camera phones are increasingly employing OLEDs, making the use of such back-light modulation unnecessary.

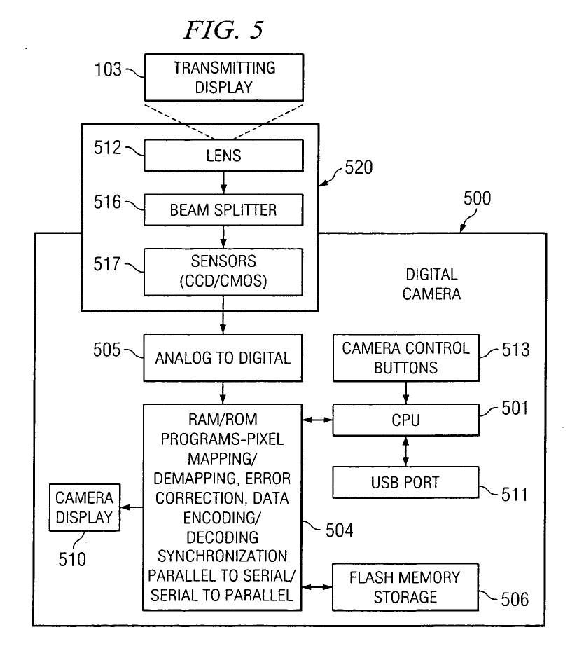

FIG. 5 is a diagrammatic illustration of an embodiment of digital camera 500 adapted to employ embodiments of the present systems and methods. Digital camera 500 may be used as a receiver appliance (102 of FIG. 1). Alternatively or additionally, digital camera 500 may be used as a transmitter data source (101 of FIG. 1). As noted above, digital camera 500 need not employ any additional hardware, only software, to implement the present invention. As digital camera 500 is tuned for high bandwidth throughput for both its camera element 520 and its display screen 510, digital camera 500 can provide very power efficient data transfer in accordance with the present invention. High level applications executed by CPU 501 and ROM/RAM 504 enable digital camera 500 to act as either a receiver appliance or a data source. When implemented via executable instructions, various elements of embodiments of the present invention are in essence software code defining operation of various elements of digital camera 500. The executable instructions or software code may be obtained from a readable medium such as, removable flash memory 506, ROM 504, or USB port 511 and/or the like. ROM/RAM 504 and/or flash memory 506 may hold user and system data and programs, as is well known in the art. CPU 501, and ROM/RAM 504, may carry out the serial to parallel, and parallel to serial conversion of data, as well as data encoding, FEC, pixel mapping, pixel demapping, error correction, data decoding and synchronization, described above. Additionally, CPU 501 and ROM/RAM 504 may carry out camera control functions.

Digital camera 500 may also include conventional components. For example input to digital camera 500 may be accomplished via camera control buttons 513. Data may be output, and data and/or applications may be conventionally transferred into digital camera 500 via USB port 511, possibly via a wireless transceiver (using supported BLUETOOTH or Wi-Fi protocols), and/or via removable flash memory 506.

However, in accordance with the present invention data to be transferred into digital camera 500 may be displayed on transmitting device screen 103. In FIG. 5 a transmission medium may comprise transmitter display 103 and camera element 520 with its associated lens 512 and beam splitter 516. Lens 512 focuses incident light from display 103 which may be split by beam splitter 516 to impinge on separate sensors 517 used to capture different colors, such as additive color primaries red, green and blue, of the image of transmitting display 103. Digital camera 500 typically has at least VGA resolution and may have a resolution in the megapixel range. Captured light information is converted from an analog to a digital electronic format in Analog to Digital converter (A/D) 505. In accordance with the present invention, digital camera logic, typically resident in ROM/RAM 504 of digital camera 500, processes brightness and color information made available in an electronic format, by carrying out inverse pixel mapping, decoding, error correction and synchronization. Resultant data may be output for storage to flash memory 506 received by digital camera 500.

When digital camera 500 is acting as a data source, data, such as a data file that may be stored in associated flash memory 506 may be converted from a serial stream into one or more parallel data streams by programs operating in ROM/RAM 504 and executed by CPU 501. Similarly, a pixel mapper operating in ROM/RAM 504 and executed by CPU 501 encodes the data for transmission on digital camera display 510, in such a manner as to maximize data throughput. Error correction may be incorporated into the data by ROM/RAM 504 and CPU 501 as well, prior to transmission on screen 510. The encoded data is sent to digital camera display 510 and may be presented in the background as described above, without changing display content perceived by a digital camera user. The data may be transmitted in parallel fashion using multiple “data screens” which can be displayed on different regions of digital camera display 510. As noted above LCD displays, such as digital camera display 510 have relatively lower contrast and brightness. Therefore, when a digital camera 500 is transmitting data it may employ a back-light to modulate the LCD. However, digital cameras are increasingly employing OLEDs, making the use of such back-light modulation unnecessary.

Various implementations of the present invention call for specific considerations. For example, a billboard acting as a transmitter in accordance with the present invention should be able to display graphical information as is the billboard's primary purpose. As a more specific example, a billboard in an airport showing flight schedule information needs to display all the flight information for various flights at all times, so data would need to be transmitted in the background as described above.

ATM displays are typically CRT-based or older LCD-based, often monochrome. However, use of the present invention in communicating with a ATM will generally be for the purpose of obtaining limited amounts of data such as a receipt, statement, or token for security/authentication purposes. ATMs may be retrofitted to employ the present invention without undue modification. Software may be used to enable an ATM to encode the desired data and modulate the screen to provide data for reception by a camera-enabled device in accordance with the present systems and methods.

Panel indicators or enunciators, such as employed by various electronic devices can be used to transmit information to a camera-enabled device. Examples of such panel indicators may be LED lights, LCD displays on printers, or the like. In accordance with the present invention, an LED indicator may be modulated to blink to transmit data that may be received by a camera-enabled device, whereas an LCD panel display may be modulated to transmit data in accordance with the description of FIG. 1, above.

Many traffic lights use LEDs. These traffic lights may be modulated in accordance with the present invention to provide transmission of data at a very fast data rate. For example, traffic information and the like may be transmitted, or broadcast, to camera-enabled devices in accordance with the present invention.

Security cameras, such as deployed in public places may be enabled to receive information as a background task, with a monitoring system enabled to detect incoming data messages. For example, security cameras may be enabled to receive distress calls or signals employing the present systems and methods.

In accordance with the present systems and methods, text information such as subtitles or closed captioning can be encoded into image content of a television broadcast or the like. Resultantly, a camera-enabled device enabled for data reception in accordance with the present invention may be pointed at the television screen and subtitles, closed captioning text or supplemental information will be displayed by the camera-enabled device. For example, a sports program might be supplemented with statistical data or the like.

The present systems and methods may also employ tuning and aiming tools. For example, a display of a receiving camera-enabled device might show through color or grayscales, data throughput rates associated with regions of the transmitting screen to aid in aligning the receiver camera with the transmitting screen.

1. A method comprising:
encoding data by a first device;
displaying the encoded data on a display of a first device;
capturing an image of said encoded data displayed on said display with a camera associated with a second device; and
converting said image to said data by said second device.

2. The method of claim 1 further comprising converting a serial stream of said data into parallel streams of data.

3. The method of claim 2 wherein said parallel streams each contain all of said data.

4. The method of claim 2 wherein each of said parallel streams each contain a portion of said data.

5. The method of claim 1 wherein said encoding further comprises applying error correction to the encoded data.

6. The method of claim 1 wherein said displaying is carried out in a plurality of regions of said display.

7. The method of claim 1 wherein said displaying is carried out in a reserved portion of said display.

8. The method of claim 1 wherein said displaying further comprises incorporating said encoded data into content being displayed on said display.

9. The method of claim 8 wherein said encoded data cannot be perceived by a user of said display.

10. The method of claim 1 wherein said encoding provides security.

11. The method of claim 1 wherein said capturing is carried out by a digital camera.

12. The method of claim 11 wherein said camera is connected to said second device.

13. The method of claim 11 wherein said camera is integrated into said second device.

14. The method of claim 1 wherein said first device is at least one of a general purpose processor-based device, a personal digital assistant, a digital camera, a telephone, an automatic teller machine, a bill board, a panel indicator, a traffic light, and a television.

15. The method of claim 1 wherein said second device is at least one of a personal digital assistant, a digital camera, a telephone, a security camera, and a general purpose processor-based device.

16. A system for transferring data comprising:
a first device hosting data to be transferred and selectively displaying said data in an encoded format; and
a second device comprising:
an imaging device capturing an image of the encoded data displayed by said first device; and
logic for decoding said encoded data to provide said data in said second device.

17. The system of claim 16 wherein said first device comprises pixel mapping logic encoding said data.

18. The system of claim 16 wherein said first device comprises logic encoding error correction in the encoded data.

19. The system of claim 16 wherein said first device comprises logic converting a serial stream of said data into parallel streams and displaying said parallel streams of encoded data on different regions of a display screen.

20. The system of claim 19 wherein said parallel streams each contain the same encoded data, streamed at different throughput rates.

21. The system of claim 19 wherein each of said parallel streams each contain a portion of said encoded data, streamed at a same throughput rate.

22. The system of claim 16 wherein said first device is at least one of a general purpose processor-based device, a personal digital assistant, a digital camera, a telephone, an automatic teller machine, a bill board, a panel indicator, a traffic light and a television.

23. The system of claim 16 wherein said imaging device comprises a digital camera.

24. The system of claim 23 wherein said digital camera is connected to said second device.

25. The system of claim 24 wherein said second device is a general purpose processor-based device.

26. The system of claim 23 wherein said camera is integrated into said second device.

27. The system of claim 26 wherein said second device is at least one of a personal digital assistant, a digital camera, a telephone, a security camera, and a general purpose processor-based device.

28. A data transmission medium comprising:
a display displaying encoded data; and
a camera-enabled appliance adapted to capture an image of said encoded data displayed on said display for decoding.

29. A system for transferring data comprising:
means mapping select portions of data to be transferred for display in at least one encoded format;
means for displaying the encoded data according to said mapping;
means for imaging the displayed encoded data; and
means for demapping said encoded data shown in a resulting image to provide said data.
